(19) United States
(12) Patent Application Publication
(10) Pub. No.: US 2017/0061075 A1
(43) Pub. Date: Mar. 2, 2017

(54) METHOD FOR SIGNAL AND DATA ANALYSIS FOR DETERMINING WARNING SIGNALS FOR PATHOLOGICAL CONDITIONS AS WELL AS CORRESPONDING DEVICES AND SYSTEMS

(71) Applicant: DRÄGERWERK AG & CO. KGAA, Lübeck (DE)

(72) Inventors: Petra SCHIWIAKA, Lübeck (DE); Desislava NIKOLOVA, Hamburg (DE); Angela SCHOBER, Hamburg (DE)

(21) Appl. No.: 15/119,924

(22) PCT Filed: Feb. 13, 2015
(86) PCT No.: PCT/EP2015/000318

§ 371 Date: Aug. 18, 2016

(30) Foreign Application Priority Data
Feb. 19, 2014 (DE) 10 2014 002 173.4

(51) Int. Cl. G06F 19/00; G06F 17/30

(52) U.S. Cl. CPC G06F 19/322; G06F 19/3406; G06F 19/345; G06F 17/30477

(57) ABSTRACT

A method, device, system data analysis determines warning signals for pathological conditions. Measured data is collected from a patient data management system with a data interface. Data sets relevant to pathological conditions are analyzed and sensor signals of a user terminal are analyzed that are relevant to pathological conditions. Auxiliary signals are determined for the conditions when results of the analyses are positive. A most recently determined auxiliary signal is displayed. Further data sets are analyzed subsequent to auxiliary signals being determined. A further auxiliary signal is determined for a further condition when result of the analysis of the further data set is positive. An analysis is made of a further sensor signal subsequent to the determination of the further auxiliary signal. Another auxiliary signal is determined for another condition when a result of the analysis of the further sensor signal is positive subsequent to determining the further auxiliary signal.

### CROSS REFERENCE TO RELATED APPLICATIONS

This application is a United States National Phase Application of International Application PCT/EP2015/000318 filed Feb. 13, 2015 and claims the benefit of priority under 35 U.S.C. §119 of German Application 10 2014 002 173.4 filed Feb. 19, 2014, the entire contents of which are incorporated herein by reference.

### FIELD OF THE INVENTION

The present invention pertains to a method for signal and data analysis for determining warning signals for pathological conditions by means of an analysis device, comprising the steps:
collection of measured data from a patient data management system by means of a data interface of the analysis device,
displaying of at least some of the measured data by means of a display of a user terminal, which display can be coupled to the analysis device,
analysis of a first data set of the measured data, wherein the first data set is relevant to a first pathological condition,
determination of a first auxiliary signal for the first condition when a result of the analysis of the first data set is positive,
analysis of a sensor signal (input signal) of the user terminal when the first auxiliary signal has been determined beforehand, wherein the sensor signal is relevant to a second pathological condition,
determination of a second auxiliary signal for the second condition when a result of the analysis of the sensor signal is positive,
analysis of a second data set of the measured data when the second auxiliary signal has been determined beforehand, wherein the second data set is relevant to a third pathological condition and is different from the first data set,
determination of a third auxiliary signal for a third condition when a result of the analysis of the second data set is positive, and
displaying of the most recently determined auxiliary signal in each case by means of the display of a user terminal, which display can be coupled to the analysis device.

In analogy to the method, the present invention pertains to an analysis device and a system for signal and data analysis for determining warning signals for pathological conditions. An auxiliary signal for a corresponding condition determined in this manner is used to support decision-making in the early detection of an acute illness, for example, a septic illness. In addition, the present invention pertains to a corresponding computer program and a computer program product.

### BACKGROUND OF THE INVENTION

To support hospital staff (physicians and nursing staff) and also patients in making decisions about a suitable health care for specific clinical issues, such as the early detection of a septic illness, there are medical directives and guidelines that are based on systematically developed findings and represent the current medical knowledge. While directives are binding, the guidelines must each be adapted to the particular case.

The following stages of sepsis are known:

1. SIRS (Systemic Inflammatory Response Syndrome). This condition is defined by at least two of the following criteria:
Fever or hypothermia, which is confirmed by a rectal, intravasal or intravesical measurement,
tachycardia with a heart rate above 90 bpm (beats per minute),
tachypnea with a rate above 20 bpm or hyperventilation (CO₂ partial pressure, PaCO₂<4.3 kPa<33 mmHg), and
leukocytosis (>1,200 pro/mm3) or leukocytopenia (<4,000 pro/mm3) or >10% immature neutrophils in the differential blood picture;
   2. sepsis, defined as SIRS in response to an inflammatory process (infection);
   3. severe sepsis, defined as sepsis with an organ dysfunction or a tissue hypoperfusion;
   4. septic shock, defined as severe sepsis as well as a systolic blood pressure of <90 mmHg for at least one hour.

Detection of the stage of sepsis is a highly complex process, which is based on a plurality of different sensor data. There are directives for prevention, diagnosis, treatment and aftercare of a septic illness (for example, from the Deutsche Sepsisgesellschaft e.V. [German Sepsis Society, registered society], also designated hereinafter as DSG or an American counterpart, the SSC [Surviving Sepsis Campaign]).

The medical knowledge is becoming more and more comprehensive and complex, and the guidelines depict this knowledge in text form. During medical treatment, especially acute medical treatment, the guidelines are practically basically unavailable to the hospital staff in their decision-making because fast decisions are becoming increasingly necessary in routine clinical practice.

Computer-implemented systems that resort to recommendations from the guidelines and/or from clinical practice are already available to the hospital staff to support decision-making.

A software-implemented system to support decision-making comprises, for example, a rule engine, which processes parameters in the form of electronically available data on the basis of stored clinical knowledge and outputs a result after a complete run through a decision tree. The system may be used, for example, in an acute medical area of a hospital. For example, the “Clinical Advisories,” “IntelliVue” system from the firm of Philips should be mentioned here. A drawback of these systems is that the user does not receive any interim results that explain the illness and the degree of severity thereof. As long as the decision tree could not be completely run through, for example, because measured values or confirmations for a condition determination are missing, the hospital staff does not receive any indication of a tendency of the development of the septic illness. This takes place only if the condition of the septic illness corresponding to a stage can actually be determined.

According to the checking protocol of said directives and guidelines, it should first be checked whether the sepsis stage “SIRS” is present. The criteria already mentioned as corresponding should be analyzed for this. If a “SIRS” is present, the next thing would be to check whether the sepsis stage “SEPSIS” is present. This is the case if an infection is added to the SIRS. The infection is possibly confirmed by the hospital staff on a user terminal, as a result of which a corresponding sensor signal (or input signal) is generated by the user terminal. With confirmation of the infection, a condition transition then takes place from the sepsis stage “SIRS” to the sepsis stage “SEPSIS.” The prerequisites for a septic shock or a severe sepsis are first checked when the sepsis stage “SEPSIS” is reached.

However, it was found in practice that an infection often develops unnoticed in a patient. Simultaneously or subsequently, the state of health of a patient may deteriorate to the extent that the prerequisites for a condition transition from a sepsis stage “SEPSIS” to septic shock or severe sepsis are present. The septic shock or severe sepsis is, however, not detected since the sepsis is not yet confirmed as such. Two successive conditions now depend on a confirmation of infection.

A major drawback of known systems is thus that one at first waits for a confirmation of the infection without giving an indication of signs of septic shock or severe sepsis. Thus, the increased urgency of checking for an infection is not explained to the user. Because of this, the patient may develop, for example, severe sepsis, while the system waits for additional parameters or inputs for confirming the infection. When the system outputs a message for a potentially present infection, this message must first be confirmed by the user by checking for infection before the system can detect the signs of an organ dysfunction and thus the presence of severe sepsis or septic shock and can display them to the user. Even though the clinical picture may consequently have already changed while waiting for the confirmation of the infection, the attention of the user is not drawn to the possibly already present exacerbated condition of severe sepsis or septic shock.

Support means which also automatically indicate a further exacerbation of the patient's state of health in case of an unobserved or hitherto not yet confirmed infection are hence desirable.

### SUMMARY OF THE INVENTION

An object of the present invention is to provide a method, a device and a system, which improve and especially accelerate the early detection of an acute illness, for example, a septic illness. Moreover, the drawbacks described above in systems from the state of the art shall be overcome.

According to a first aspect, the object is accomplished by a method for signal and data analysis for determining warning signals for pathological conditions by means of an analysis device, comprising the steps:
collection of measured data from a patient data management system by means of a data interface of the analysis device,
displaying of at least some of the measured data by means of a display of a user terminal, which display can be coupled to the analysis device,
analysis of a first data set of the measured data, wherein the first data set is relevant to a first pathological condition,
determination of a first auxiliary signal for the first condition when a result of the analysis of the first data set is positive,
analysis of a sensor signal (input signal) of the user terminal when the first auxiliary signal has been determined beforehand, wherein the sensor signal is relevant to a second pathological condition,
determination of a second auxiliary signal for the second condition when a result of the analysis of the sensor signal is positive,
analysis of a second data set of the measured data when the second auxiliary signal has been determined beforehand, wherein the second data set is relevant to a third pathological condition and is different from the first data set,
determination of a third auxiliary signal for a third condition when a result of the analysis of the second data set is positive,
displaying of the most recently determined auxiliary signal in each case by means of the display of a user terminal, which display can be coupled to the analysis device,
analysis of a third data set of the measured data when the first auxiliary signal has been determined beforehand, wherein the third data set is relevant to a fourth pathological condition and is different from the first data set,
determination of a fourth auxiliary signal for the fourth condition when a result of the analysis of the third data set is positive,
analysis of the sensor signal of the user terminal when the fourth auxiliary signal has been determined beforehand, and
determination of the third auxiliary signal for the third condition when a result of the analysis of the sensor signal is positive and the fourth auxiliary signal has been determined beforehand.

The present invention will be described below on the basis of the method. Embodiments mentioned here, alternative solutions with additional features and advantages are likewise extrapolated to the other aspects of the invention as well, i.e., to the analysis device, the system, the computer program and the computer program product and vice versa. Accordingly, features of the invention that are written and/or described with regard to the method, may also be extrapolated to the device and system and vice versa. In this case, the particular functional features of the method for the analysis device and/or for the system are implemented by corresponding circuit modules or microprocessor blocks, which are configured to provide the particular functionality.

It is now possible with the method according to the present invention to give an indication of signs of a subsequent, important condition, such as septic shock or severe sepsis, without having to wait for a confirmation of an infection or of a specific condition. With the introduction of the fourth condition, the increased urgency of checking for a specific, subsequent condition, preferably for an infection, is explained to the user. A patient can thus be effectively prevented from developing severe sepsis, for example, while waiting for an additional parameter or input regarding confirmation of the infection. The user may thus be informed about problematic constellations as early as possible by means of the fourth condition in order to be able to possibly introduce additional measurements and/or actions.

In the sense of the present invention, a pathological condition is a condition that can be calculated and can thus be determined automatically based on measured data and/or on at least one sensor signal.

The measured data are the result values of measurements of physiological measured quantities of a patient. In addition, the measured data may include result values of physical, chemical or biological measured quantities that were measured on or in the patient. The measured data may include, for example, result values which represent a body temperature, a heart rate, a respiratory rate, a blood pressure and/or a white blood cell count of a patient. Thus, the measured data may represent the vital data of a patient.

The measured data may be value-discrete and/or time-discrete. The measured data may be collected in an automated manner. The measured data may originate from a medical device or a plurality of medical devices. Medical devices are, for example, ventilators, anesthesia devices, patient monitors, hemodynamic monitors, laboratory equipment (for example, for blood analysis), body temperature measuring devices, respiratory rate measuring devices, blood sugar measuring devices, electrocardiographs, electrical impedance tomographs, electroencephalographs and/or electromyographs. The measured data may include, for example, body temperature (T), heart rate (HR), blood pressure and/or a white blood cell count. The measured data may be value-discrete and/or time-discrete. The measured data may be collected in an automated manner and/or be input manually.

Provisions are made for a user terminal to be available to the user for execution of the method. This user terminal can be coupled to a display. The display may consequently be directly physically connected to the user terminal or be integrated into the user terminal. As an alternative or in addition, a display may be connected and thus correspondingly coupled to the user terminal via a data link. This may take place, for example, by actuating a switch. As an alternative or in addition, the sensor signal (input signal) may be generated by means of manual contact of a touch display and/or by actuating another input unit of the user terminal. The sensor signal is especially preferably created by at first a confirmation symbol being outputted on a display of the user terminal, and by the user touching the confirmation symbol on the display (to create the sensor signal/input signal). Thus, the sensor signal is preferably not measured data because the measured data are collected by means of a data interface from a patient data management system.

A patient data management system is a system for computer-assisted storage and making available of measured data that characterize a patient. The patient data management system is consequently used to consolidate, collect, input and/or acquire the often different measured data of a patient.

The data interface may be configured according to the PUSH or PULL principle. In a preferred first embodiment of the present invention (PULL operation), the data interface actively requests the collection of the measured data. As an alternative, collection of the measured data may be triggered by the patient data management system according to a likewise advantageous second embodiment, preferably as soon as this system provides new or updated measured data (PUSH operation). The collection of the measured data may be activated continuously, quasi-continuously and/or repeatedly or by request of the user.

The analysis device is preferably a physical, objective device to be used in the clinical environment, which is preferably used in the area of intensive care. As an alternative, provisions may be made for the analysis device to be configured as a logic unit or instance of an electronic data processor. The analysis device may be configured with interfaces, especially data interfaces or output interfaces, in order to be connected to other medical devices. Thus, the analysis device may be coupled especially to a display of a user terminal in order to optically display at least some, especially a predetermined or selectable selection, of the measured data. In addition, provisions may be made for the analysis device to be integrated into another electronic device, e.g., into a telecommunications terminal (smartphone, tablet PC, etc.), or together with the patient data management system in an electronic device.

The analysis device may be configured as a processor or a microprocessor. In another configuration, the analysis device may be implemented as hardware implementation, e.g., as ASIC (Application Specific Integrated Circuit) or as FPGA (Field Programmable Gate Array). The analysis device may be entirely or partly implemented as a software application that can be provided on different systems in another likewise preferred embodiment. Thus, it is possible to provide the software-implemented analysis device or the software-implemented sections of same on a stand-alone computer (personal computer, computer network, mobile terminal, laptop, etc.) or to integrate and implement same into a patient data management system, on the one hand. On the other hand, the analysis device may be integrated into an electronic device as a physical structural unit as well. A particularly preferred embodiment pertains to implementation of the analysis device on a mobile terminal (e.g., tablet PC). The mobile terminal may comprise a touchscreen (as a touch-sensitive display). One embodiment pertains to a surface-capacitive touchscreen. Alternative configurations refer you to inductive or projected-capacitive touchscreens.

The user terminal with the display may be any terminal that can be used in the clinical environment. Therefore, the user terminal may be a medical device with a display. A selection of known medical devices was already mentioned, to which reference is made here. A user terminal may, however, also be a mobile hand-held device with a wireless data interface and a display. The display may be configured as an electronic component for outputting a signal. The user terminal preferably includes a touch-sensitive display or it is configured as such.

Provisions are preferably made for at least all measured data relevant to the condition determined in each case to be displayed. Provisions may especially preferably be made for the available measured data which are relevant to a not yet determined condition to be displayed as well. The measured data not yet available for a not yet determined condition may be displayed in each case by a corresponding free variable parameter or symbol. The advantage is thus gained that the user is immediately referred to possibly necessary actions (e.g., for data collection).

As mentioned above, the patient data management system is used mostly to consolidate, collect, input and/or acquire often different measured data of a patient. These measured data may characterize a patient. In addition, the measured data may in most cases be categorized as different parameters. Thus, for example, one parameter each may be provided for the heart rate, the blood pressure, the respiratory rate and/or the like. Each of the parameters or a specific selection of the parameters may be relevant to a specific condition. Provisions are made for a data set of the measured data to be selected in each case to keep the analysis of the measured data as efficient as possible. Such a data set may therefore comprise a sub-quantity of the measured data and/or a specific selection of the parameters of the measured data.

Specific measured values or a selection of measured values—each preferably also called a data set of the measured values—are relevant to the condition. Hence, they represent corresponding measured quantities such as physical, chemical or biological measured quantities, which are relevant during a monitoring of sepsis and can make possible conclusions about a septic condition that correlates with the corresponding measured quantities, which were measured on or in the patient. In analogy to the measured values, connections as mentioned above may also apply to a sensor signal (input signal).

Conditions can be divided into a plurality of classes of a septic illness, particularly including a SIRS (systemic inflammatory response syndrome), an organ dysfunction (corresponds to a malfunction of an organ), a sepsis, a severe sepsis and/or a septic shock. This classification corresponds to the current directives of the DSG e.V. (German Sepsis Society). The first condition especially preferably corresponds to a SIRS, the second condition corresponds to a sepsis, the fourth condition to an organ dysfunction and/or the third condition to a severe sepsis or to a septic shock. The classification may be defined in a phase of preparation. In addition, the conditions may also include the classes “no infection” or an “undefined condition.” Furthermore, there may be two statuses for each condition: One unconfirmed and one confirmed. The unconfirmed status may be transformed into a confirmed status by a confirmation input on a button provided on the display, especially the user terminal. This can be automatically noted in the system. In particular, the conditions are represented with their status in a graphic symbol on a user surface by means of the display.

Not every parameter of the measured data has an effect on one of the conditions. In addition, one of the parameters may have an effect on one of the conditions, but the same parameter has no or at least almost no effect on another condition. Preferably only specific measured values and/or sensor signals, namely those with the corresponding effect, are hence relevant to the determination of an auxiliary signal for a condition. To be able to also keep the analysis here as simple and efficient as possible, the selection of the measured values to be taken into consideration or auxiliary signals may be reduced to those with an especially high effect on the corresponding condition. Hence, provisions are made for a first data set of the measured data to be analyzed in order to determine a first auxiliary signal for a first condition. The same applies to the remaining conditions and auxiliary signals. A data set may hence be reduced to a partial quantity of the measured data and/or to the parameters of the measured data which has or have a specific effect on the corresponding condition. The measured data and sensor signals may, for example, be relevant to a condition if they or their values correlate with physical, chemical and/or biological measured quantities, which allow conclusions to be drawn about a septic condition.

The term “analyze” refers to an automated and computer-implemented analysis of the measured data that are relevant to a septic condition. It is possible by means of the analysis to calculate whether the measured data have a value and/or a tendency that can be associated with a septic condition. The analysis comprises, for example, a comparison of measured quantities of the measured data with corresponding threshold values. As an alternative or in addition, a comparison of gradients of the measured quantities with corresponding threshold values may be carried out. A result of the analysis may then indicate whether the measured data have values and/or tendencies that can be associated with a septic condition. This may, for example, be the case if at least one measured quantity of the measured data is greater than a corresponding threshold value and/or if at least one gradient of a measured quantity of the measured data is greater than a corresponding threshold value. In other words, the measured values and/or the sensor signal for analysis may be checked for noncompliance with a predefined normal range or at least one threshold value in order to output a positive result in case of a lack of compliance. The analysis is preferably patient-related and/or patient-specific. In addition, the measured data relevant to the corresponding condition can be used for the corresponding analysis. These are, for example, measured quantities of sensor signals and/or sensor data and/or measured values of measured data. The analysis of measured data and sensor signals may hence be configured analogously.

Provisions are made according to the present invention for various auxiliary signals to be able to be determined for the conditions. The corresponding auxiliary signal for the corresponding condition is activated when a result of a corresponding analysis is positive. In addition, it is possibly required that an auxiliary signal for a different condition be determined beforehand. Therefore, a transition from the previous condition to each new condition is carried out through the determination of an auxiliary signal for a new condition and subsequent, manual confirmation by the user. Upon reaching a new condition, the previous condition can thus be cancelled. If the prerequisites for the current condition are no longer present, a condition transition may also take place in the reverse direction, i.e., from the current condition to the previous condition, wherein a corresponding confirmation of withdrawal by the user must be made.

The most recently determined auxiliary signal of a condition in each case can be displayed visually on the display of the user terminal. Provisions may be made for the most recently determined auxiliary signal for a condition to be displayed as a visually perceptible signal (e.g., in the form of a symbol) or as a complex optical signal in the form of a tabular display. In an overview display, a plurality of attributes for a patient can be visualized in a line or column. The attributes preferably comprise an identification of the patient (e.g., about the name or about an identification number), a classification of the condition (sepsis status), a position signal (e.g., by identification of the respective bed or department) and/or other, configurable parameters relevant to the condition. In addition, an additional confirmation field may also be provided. It is possible to identify whether the condition corresponding to the auxiliary signal is already confirmed or not (unconfirmed) in the confirmation field. The confirmation may be made via the display, which can be configured as interactive for this purpose, by means of an input signal by the medical staff (possibly the user). In addition, the most recently determined auxiliary signal for the condition can be outputted as an acoustic signal. For this, the user terminal may possess a corresponding acoustic output unit. However, the auxiliary signal is usually visualized as an output on a monitor. The visualization of the auxiliary signal is preferably interactive such that buttons, with which a user can initiate additional actions and/or procedures (and especially the display of a patient-specific detailed view or of commands for requesting still missing data) are provided on the surface of the display or of the monitor. Provisions are made according to the present invention for the most recently determined auxiliary signal for a condition in each case to be displayed by means of a display.

The analysis device may also comprise another interface, in particular a rule engine interface, which is preferably an interface to a database, in which a workflow for processing and/or for analyzing the collected measured data and/or the at least one sensor signal is stored. The database may be implemented as a knowledge base. The directives for assessing septic illnesses may also be stored in the knowledge base. The database and/or the knowledge base may advantageously be configured as physically independent of the analysis device. The database is preferably connected as a separate instance of the analysis device. A rule engine may also be implemented in the database in order to determine how the corresponding measured data and the at least one sensor signal are to be processed and/or analyzed.

A preferred embodiment of the method is characterized in that the analyses are executed according to a workflow. The workflow is preferably an electronic representation of a workflow with a sequence of commands for data and/or signal processing. In this connection, it may be a processing with time requirements for when which calculations are to be executed. As an alternative, a decision tree may be implemented, which is usually hierarchical and comprises a plurality of branches. A sequential structure, which is based on the fact that specific data and/or signals are processed at a specific time, is usually preset. The workflow may be determined dynamically and in particular as a function of which data and sensor signals have been collected and which have not (yet) been collected.

According to a preferred embodiment of the present invention, a specific auxiliary signal is outputted by means of the display for a condition, which comprises a graphic representation of a classification of the measured data and/or of the at least one sensor signal in sepsis classes according to the sepsis directives stored in the database. In a configuration phase, additional classes in relation to sepsis may also be added here. Thus, it is, for example, possible to include at least one other class in addition to the four classes mentioned above. Different symbols and/or different identifications are preferably associated with the different sepsis classes. Thus, for example, an auxiliary signal for a septic shock may be identified by the color red and by a square-shaped symbol, while an auxiliary signal for sepsis is represented by the color yellow (with a round-shaped symbol). This has the advantage that a user receives even more information and can see immediately at a glance which sepsis classification and thus which auxiliary signal was calculated for the corresponding sepsis condition. It is preferable to identify when the measured data in question or the at least one sensor signal corresponding to the particular sepsis classification exceed or fall short of the limit value. If, for example, the exceeding of the “heart rate” is causative for the classification “severe sepsis,” the causative measured value is thus displayed, for example, in the same color or in a different consistent emphasis than the sepsis class “severe sepsis.” Different identifications are thus used for different sepsis conditions. Different identifications are preferably also used for when the different measured values and sensor signals exceed and fall short of the limit value. The classification is preferably represented by a particular classification symbol and hence identifies whether the collected data and signals indicate a SIRS, a sepsis, a severe sepsis or a septic shock. The analysis is thus not a diagnosis, since it is only a calculation of data and/or signals, which suggest a medical assumption or suspicion. This suspicion must then always still be confirmed by a physician. Hence, the determined auxiliary signals of the conditions are preferably each identified as an auxiliary signal of an unconfirmed condition in their particular representation on the display.

In the rules, it can be defined that those measured data and/or sensor signals that bring about a change in an auxiliary signal are displayed on the display corresponding to the identification of the auxiliary signal. When, for example, an auxiliary signal for a septic shock is identified by the color “orange” in an embodiment variant, then all measured data and/or sensor signals exceeding the limit value, which bring about the change in the auxiliary signal, may automatically also be identified in orange. These are preferably the measured data and/or sensor signals that are causative for the classification of a septic shock. This automatic correspondence offers important time and performance advantages in the practical application. The user sees immediately which measured data and/or sensor signals have been used for which specific auxiliary signal of a condition. In this context, it should be noted that these conditions are preferably not patient conditions, but rather measured value conditions, with which an auxiliary signal, which indicates a possible assessment, is associated only based on calculation. This possible assessment should still be assessed and confirmed manually by the user in a subsequent step.

A preferred embodiment of the method is characterized in that the most recently determined auxiliary signal in each case is displayed by means of the display of a user terminal, which display can be coupled to the analysis device, and that with the output of the auxiliary signal, a corresponding request signal is in each case displayed by means of the display of a user terminal, which display can be coupled to the analysis device, in order to confirm or reject the corresponding condition by means of a manual entry. The user consequently receives by the displayed auxiliary signal an indication that a change in condition may have occurred. However, this requires manual checking by the user. If the user has detected the condition, he may confirm the warning signal outputted on the display. If the user does not detect the condition or if the user is of the opinion that the condition is not present, then the user can reject the auxiliary signal. Hence, the user is responsible for determining the condition.

A preferred embodiment of the method is characterized in that each of the analyses of a data set is carried out by comparing the values of the data set with a corresponding normal value ranges in each case, wherein the analysis is positive when at least one value exceeds a corresponding normal value range or when a predefined group of the values of the data set or all values of the data set exceed the corresponding normal value ranges. As an alternative or in addition, a falling short may preferably also be meant by the exceeding. The particular data set can thus be monitored and analyzed in an especially simple and continuous manner. The analysis may also be triggered by changes in the values of the data set in order to execute a new assessment in each case immediately after a change in values.

A preferred embodiment of the method is characterized in that the analysis of the sensor signal is positive if a sensor signal value of the sensor signal or the gradient thereof exceeds a corresponding threshold value in each case. As an alternative or in addition, a falling short may preferably also be meant by the exceeding. The sensor signal or the above-mentioned data set is preferably analyzed on an analog basis. The sensor signal may consequently be analyzed continuously. The comparison with a limit value may be carried out for this, wherein a positive result is determined when the sensor signal reaches or crosses the limit value.

A preferred embodiment of the method is characterized in that the sensor signal of the user terminal is detected by means of a user input unit of the user terminal. The user input unit is preferably a touch sensor of a display of the user terminal. The user may consequently use the user terminal to generate the sensor signal and possibly to make a change in the auxiliary signal of the corresponding condition. In this case, the sensor signal can assume discrete values. An analysis of the sensor signal can thus be directed toward the signal value of the sensor signal. If the signal value exceeds or falls short of the corresponding threshold value, the analysis may be positive.

A preferred embodiment of the method is characterized in that the sensor signal is generated by a user query when the auxiliary signal corresponding to the first or the fourth condition is determined. The generation of a sensor signal is not possible at any time through the user query. Rather, the times are determined by the auxiliary signals. If the first or fourth auxiliary signal are present, then a user query may be made. With this user query, a sensor signal is created, which is then analyzed. If the user query or the sensor signal created with it reveals that a corresponding threshold value is not exceeded, the result of the corresponding analysis is not positive. If, on the other hand, the corresponding threshold value is exceeded or undershot, then provisions are preferably made for the corresponding analysis to be positive. A change is then made in the auxiliary signal as a result.

A preferred embodiment of the method is characterized in that a list with entries is visualized on the display of the user terminal for the user query, wherein a corresponding sensor signal is associated with each entry. With the selection of an entry from the list, a corresponding sensor signal can be fed to the analysis. In this connection, provisions are preferably made for not every entry from the list to have a corresponding sensor signal that exceeds or falls short of a threshold value during the analysis. Thus, the selection of not every entry from the list leads to a change in the auxiliary signal.

A preferred embodiment of the method is characterized in that the third data set is equal to the second data set. Based on the first auxiliary signal for the first condition or a SIRS condition, two changes can be made in the auxiliary signals. On the one hand, a transition to the second auxiliary signal for the second condition or to a sepsis condition can be made. For this, it should be checked whether the sensor signal exceeds or falls short of a specific threshold value. On the other hand, a transition to the fourth auxiliary signal for the fourth condition or for an organ dysfunction could be made. In this case, a third data set should be analyzed. If the second signal for the second condition or the sepsis condition was determined, a transition to the third auxiliary signal for the third condition or for the severe sepsis condition can be made. A second data set should be analyzed for this. For the corresponding transition, provisions are preferably made for the same data to be analyzed, as they are analyzed for a transition from the first auxiliary signal for the first condition to the fourth auxiliary signal for the fourth condition. This is preferably the analysis of the data regarding indications for a malfunction of an organ. Hence, the second data set and the third data set may coincide. In this connection, the corresponding values are not necessarily intended, since these may change over time. Rather, the corresponding parameters are preferably intended therewith.

A preferred embodiment of the method is characterized in that the second signal is determined for the second condition when a positive result of the analysis of the sensor signal and a positive result of the analysis of the third data set are both generated (at the same time or same time range). As mentioned above, two different condition transitions can be made based on the first auxiliary signal for the first condition. In case the prerequisites for both transitions mentioned above are present at the same time, provisions are preferably made for a transition to be made to the second auxiliary signal for the second condition. As an alternative, provisions may also be made for the transition to be made to the fourth auxiliary signal for the fourth condition instead.

According to another, advantageous embodiment of the present invention, it should be interactively identified when the normal value or limit value is exceeded (or not reached). As a result, it becomes possible to detect a request signal on the display, which request signal brings about the outputting or visualization of information on the exceeding of the normal value or limit value. The information on the exceeding of the normal value or limit value may contain detailed information for the particular exceeding of the normal value or limit value of the particular measured data or of the sensor signal. This information preferably includes the particular concrete value, the time and/or a duration of the exceeding of the normal value or limit value.

The measured data, the at least one sensor signal, parameters and/or rules are preferably analyzed independently of the current condition. Thus, all cases of exceeding the normal value or limit value, which are relevant other than the current auxiliary signal, can be visualized. As a result, the attending physician can obtain additional sepsis-relevant information for the physician's diagnosis and the state of health of his patient.

According to another advantageous embodiment, with each determination of a signal for a condition, a request is generated on the display to confirm the auxiliary signal determined in each case for the corresponding condition (confirmation)—preferably by a click on a provided button—or to reject it. The latter may be executed either explicitly by a corresponding input or by a failure to act (no confirmation).

According to another advantageous embodiment, the device comprises, moreover, an updating device for updating an entry or processing position in the workflow. According to another advantageous embodiment, the device comprises, moreover, a continuation device for continuing the workflow to the updated position.

The updating device and the continuation device may be intended to generate an interim result at predefinable points in the workflow, which can be outputted as an interim signal in each case. The interim signal may thus indicate a predefinable condition that must still be validated by additional measured data and/or an additional sensor signal and/or by a user input. The user can be informed as early as possible about problematic constellations by means of the outputted interim signal in order to be able to initiate possibly additional measurements and/or actions. The continuation device preferably continues the workflow after outputting the warning signal.

In addition, other actuating variables, properties and/or commands in connection with the control of other devices or components may also be derived from the determination of the auxiliary signal.

In addition, it is possible that individual sections of the above-described method can be configured as individual, commercially available units and the remaining sections of the method can be configured as other commercially available units. As a result, the method according to the present invention can be configured as a system that is distributed to different computer-based instances (e.g., client-server instances). Consequently, it is, for example, possible that the analysis unit itself comprises different submodules that are implemented partly on a central system (e.g., a patient data management system) and partly on a browser of a mobile touchpad device and/or partly on other computer-based instances.

Another means of accomplishing the above object pertains to a computer program product practicing the method Another means of accomplishing the object provides a computer program that comprises computer instructions. The computer instructions are stored in a memory of a computer and comprise commands that can be read by the computer, which are intended for executing the method described above, when the commands are executed on the computer. The computer program may also be stored on a memory or it may be downloaded from a server via a corresponding network.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a device for sensor signal processing and support for making decisions according to an embodiment of the present invention;

FIG. 2 is a schematic view of a system for sensor signal processing and support for making decisions according to a preferred embodiment of the present invention;

FIG. 3 is a schematic view of another system for sensor signal processing and support for making decisions according to a likewise preferred embodiment of the present invention;

FIG. 4 is a schematic view of another system for sensor signal processing and support for making decisions according to a likewise preferred embodiment of the present invention;

FIG. 5 is a schematic view of a method for sensor signal processing and support for making decisions according to a likewise preferred embodiment of the present invention;

FIG. 6 is a schematic view of a simplified workflow for sensor signal processing and support for making decisions for the early detection of a sepsis according to a likewise preferred embodiment of the present invention; and

FIG. 7 is a schematic view of another system for sensor signal processing and support for making decisions according to a likewise preferred embodiment of the present invention.

### DESCRIPTION OF THE PREFERRED EMBODIMENTS

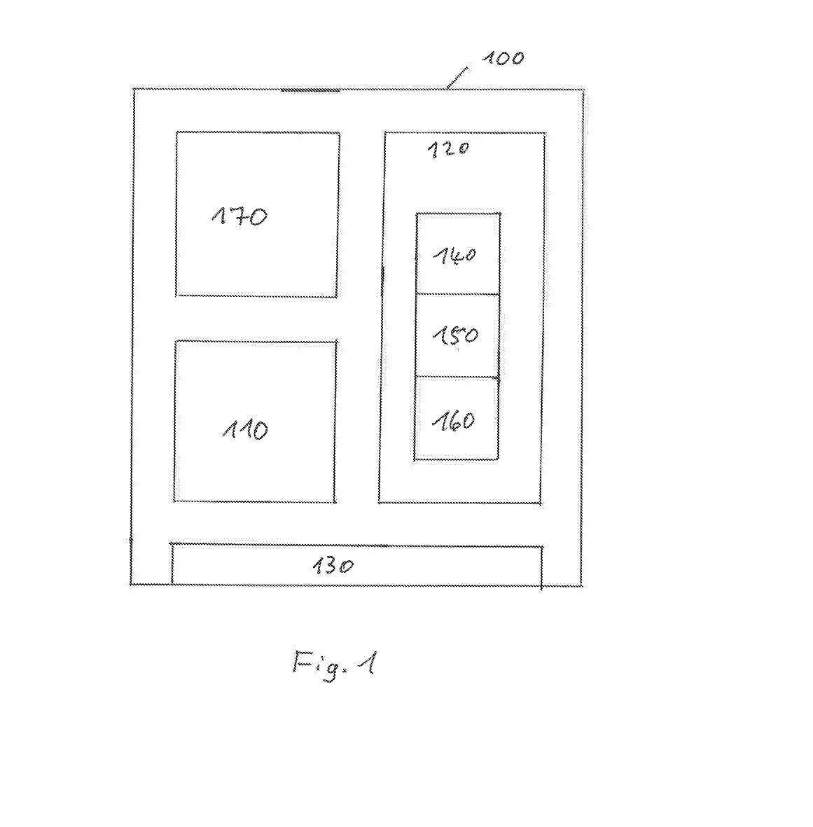

Referring to the drawings, FIG. 1 shows a schematic view of a device 100 for signal and data analysis according to an embodiment of the present invention.

The device 100 may comprise a computing unit 110, a memory 120 and an interface or data interface 130. The device 100 may be configured, for example, as a computer, such as a desktop computer, or a server (hardware) or as a terminal, such as a smartphone or a tablet computer. The computing unit 110 may be configured as a processor, for example, as a microprocessor. The memory 120 may be configured as a volatile and/or nonvolatile memory. The memory 120 is used for storing instructions (commands), for example, instructions of a program (software), such as an operating system 140 and/or an application program 150, and/or data 160, for example, measured values, such as sensor signals, parameters, range values, processing values, tables and/or rules, including assessment rules and processing rules.

The interface 130 is used for transmitting data. The interface 130 may be connected, for example, to a (higher-level) computing unit for processing and/or for storing data, for example, to a patient data management system (PDMS) for collecting and displaying patient-related information in a hospital, to a medical device, for example, to a monitoring unit and/or to a sensor unit for detecting sensor signals. The interface 130 may be configured for connection to a network, for example, to the internet, to a hospital internal network (Local Area Network, LAN) or to a WAN network (Wide Area Network) and/or to the mobile wireless network.

The computing unit 110 processes the data 160 on the basis of the stored instructions and determined results and/or partial results (also called interim results), so that the analysis of data and/or a sensor signal is implemented. In addition, the computing unit 110 can be used for support in making a diagnosis. The computing unit 110 is able to process the data of a patient or the data of a plurality of patients. The computing unit 110 is able to process the sensor signal.

The device 100 may, furthermore, comprise a display 170, for example, for the display of measured data and/or the results and/or interaction with a user. As an alternative, the display 170 may be mechanically separated from the device. In this case, the device 100 has another interface, i.e., an output interface for transmitting data to the display 170. Consequently, the user can select and/or confirm or reject, for example, patient-related measured data and results. Furthermore, the user may select a patient from a plurality of patients for display and/or interaction. As an alternative, the patient can be selected automatically, for example, on the basis of position data of the device 100 and of the patient.

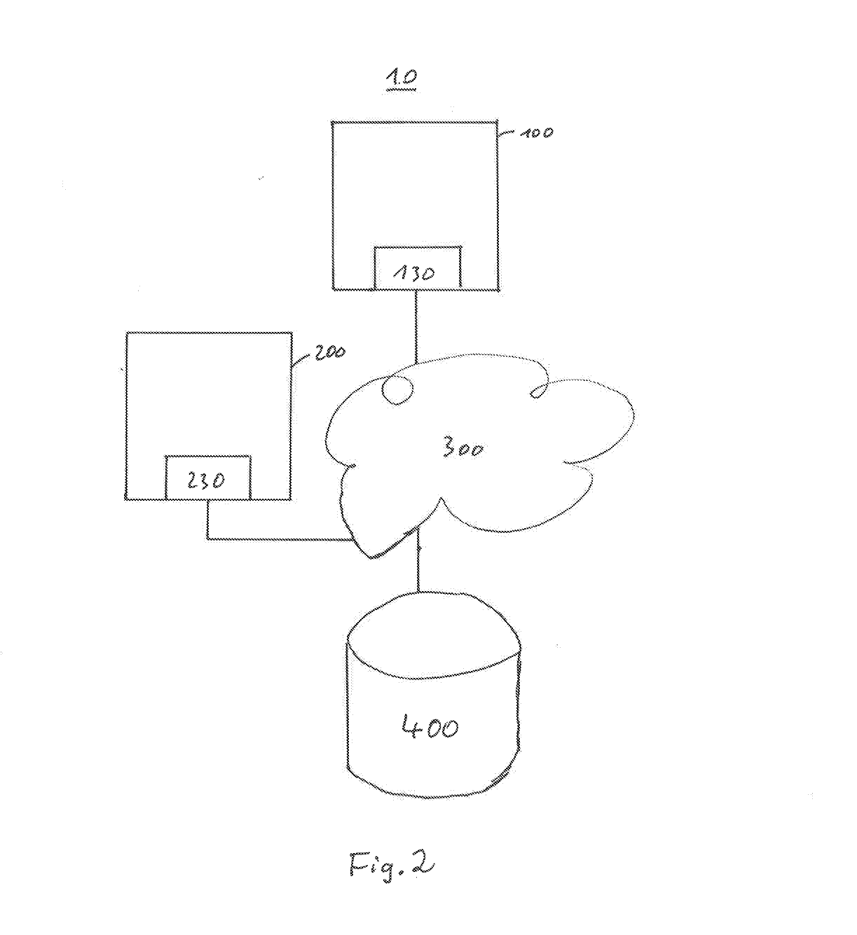

FIG. 2 shows a schematic view of a system 10 for signal and data analysis according to a preferred embodiment of the present invention.

The system 10 may comprise a device 100, a PDMS 200 and a network 300. The device 100 may essentially correspond to the device 100 already described in reference to FIG. 1. The PDMS 200 may be configured as a computer (such as a desktop computer or a server (hardware)) with an interface 230. The device 100 and the PDMS 200 are connected via their interfaces 130 and 230 to the network 300 (for example, the internet and/or the mobile wireless network), so that they can exchange data, for example, measured values, parameters and results, and/or signals over the network 300. The system 10 may, furthermore, comprise a database 400, which is connected to the network 300, for storing and/or archiving data.

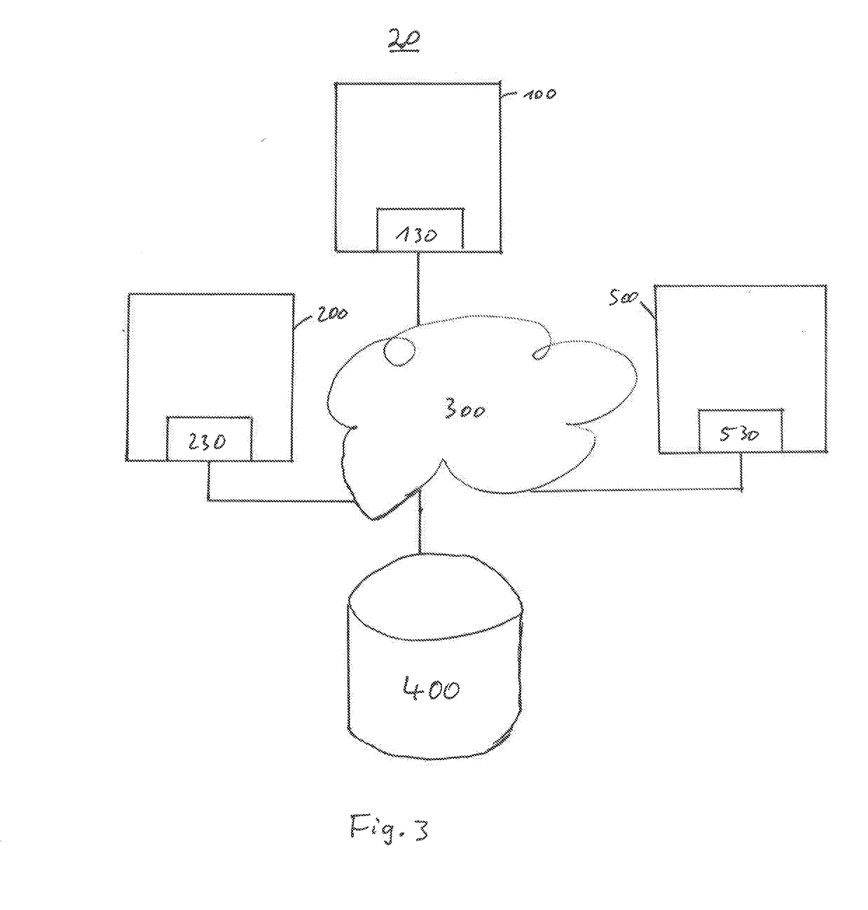

FIG. 3 shows a schematic view of another system 20 for sensor signal processing and support for making decisions according to a likewise preferred embodiment of the present invention.

The system 20 may comprise a device 100 for signal and data analysis, a PDMS 200, a network 300 and a terminal 500. The device 100 may essentially correspond to the device 100 already described in reference to FIGS. 1 and 2. The PDMS 200 may essentially correspond to the PDMS 200 already described in reference to FIG. 2. The terminal 500 may be configured, for example, as a smartphone or a tablet computer with an interface 530. The device 100, the PDMS 200 and the terminal 500 may, as already described in reference to FIG. 2, exchange data over the network 300. The device 100 may be configured as a server running software (software). The terminal 500 comprises a display, for example, for the display of the results and/or interaction with the user. The terminal 500 may include a web-based application program, for example, a web browser. The terminal 500 may be configured as a client, which is in connection with the device 100 as a server. The system may, furthermore, comprise a database 400, as already described in reference to FIG. 2.

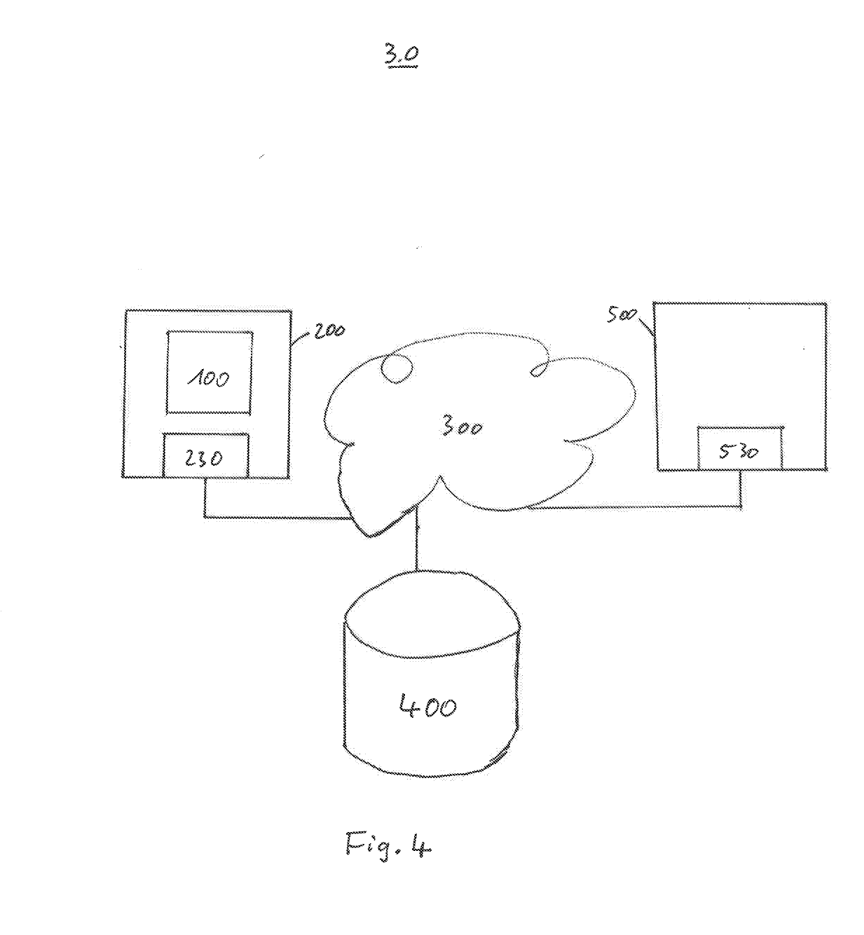

FIG. 4 shows a schematic view of another system 30 according to a likewise preferred embodiment of the present invention.

The system 30 may comprise a PDMS 200, a network 300 and a terminal 500. The PDMS 200 may essentially correspond to the PDMS 200 already described in reference to FIGS. 2 and 3 and the device 100. The terminal 500 may essentially correspond to the terminal 500 already described in reference to FIG. 3. The PDMS 200 and the terminal 500 may, as already described in reference to FIGS. 2 and 3, exchange data over the network 300. The PDMS 200 may be configured as a server (software). The terminal 500 comprises a display, for example, for the display of results and/or interaction with a user. The terminal 500 may comprise a web-based application program, for example, a web browser. The terminal 500 may be configured as a client, which is in connection with the PDMS 200 as a server. The system 30 may, furthermore, comprise a database 400, as already described in reference to FIGS. 2 and 3.

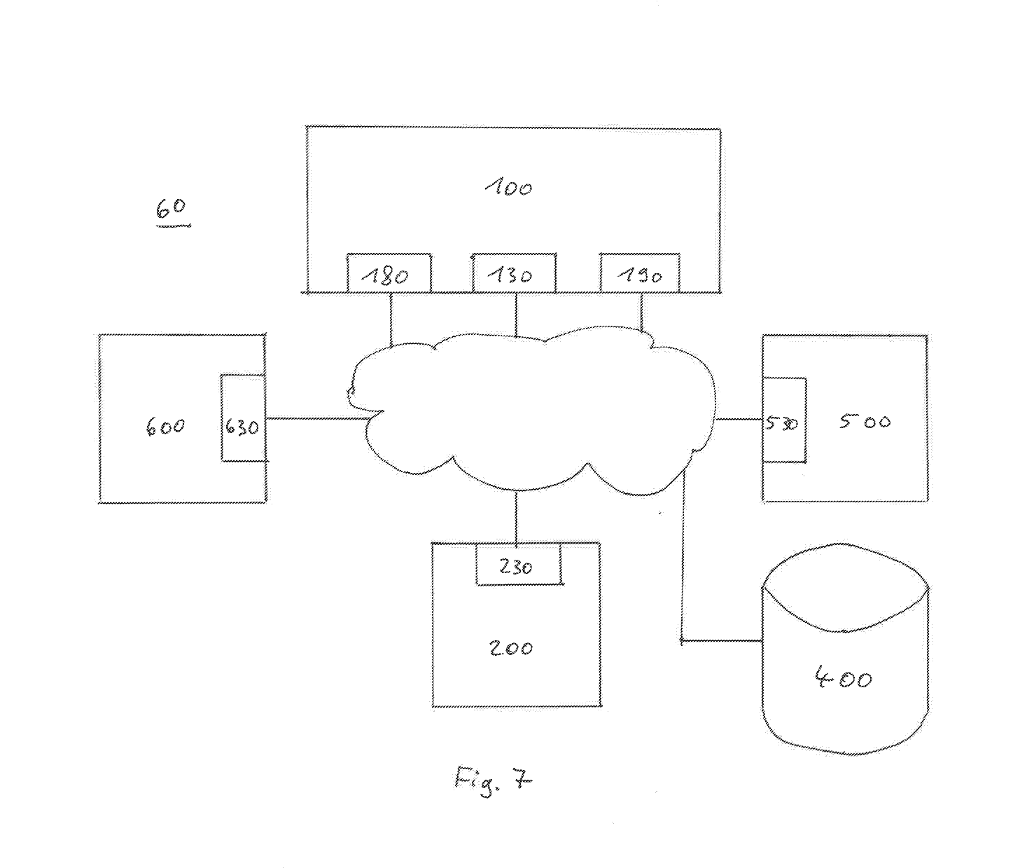

FIG. 7 shows a schematic view of another system 60 according to a likewise preferred embodiment of the present invention.

In an implementation, the system 60 comprises a device 100 configured as a controller, a PDMS 200, a network 300, a database 400, a terminal 500 and a rule analysis device 600 with an interface 630 for the transmission of signals for rule analysis and result query. The device 100 may essentially correspond to the device 100 already described in reference to FIGS. 1 and 2 and, furthermore, comprises an interface 180 for the exchange of signals and/or data with the interface 630 of the rule analysis device 600 and an interface 190, which is configured as a (web) server interface, for the exchange of signals and/or data with the interface 530 of the terminal 500. The rule analysis device 600 comprises the rules, which are stored in a memory, which is configured as a database, and a processor for the analysis of rules as a function of parameters and/or data and/or signals and for determining results, which are sent to the device 100 upon request, so that the rule application is transferred into the rule analysis device 600. The stored rules can be changed, e.g., configured or updated. As an alternative, the memory may be configured as a read-only memory (ROM), and the results are then “hardwired” or “hard-coded.” The controller 100 controls the entire signal and/or data processing and support for making decisions. The controller 100 communicates between the devices of the system 60, e.g., it communicates parameters and/or data and/or signals for calculations and analyses and delegates tasks to the devices, e.g., it triggers, i.e., starts the rule analyses and retrieves the results of the rule analyses. Furthermore, it prepares the data, signals, parameters and/or results for a visualization on the terminal 500 and provides a (web) server for a client of the terminal 500 for the transmission of signals for visualization of the parameters and results and for controlling, i.e., influencing, the system 60 via inputs at the terminal 500.

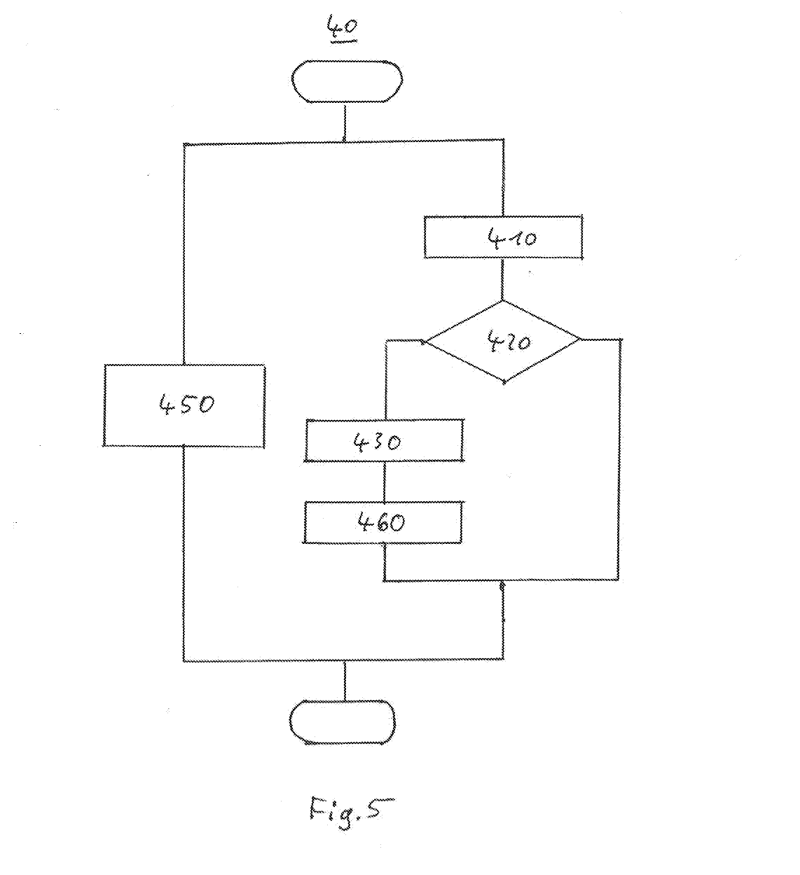

FIG. 5 shows a schematic view of a method 40 according to a preferred embodiment of the present invention.

The computer-implemented method 40 is based on recommendations from a guideline and/or clinical practice for the early detection of an illness, for example, sepsis. In this case, the clinical knowledge can be stored in the form of rules and processed as a knowledge base. The rules may each comprise one or a plurality of parameters and define a result, which depends on at least one current data value and/or signal value, so that a result value can be determined during the processing or execution of the particular rule. The method 40 may be based on a rule-based workflow, which relates the rules to one another, so that the method 40 can be completed as a function of the result values in order to provide signal and data analysis.

The method 40 comprises a collection 410 of available, condition-relevant measured data of a patient and/or sensor signals and an electronic processing 420 of the collected condition-relevant measured data and/or sensor signals with predefined condition-relevant threshold values and a determination 430 of a condition-relevant warning signal when one or a plurality of the condition-relevant measured data or the condition-relevant sensor signal reach or exceed the corresponding, predefined condition-relevant threshold values in each case. The conditions are preferably a sepsis, a SIRS syndrome (“systemic inflammatory response syndrome (SIRS)”), a “severe sepsis” or a “septic shock.” In addition, an “organ dysfunction” is preferably also considered to be a condition. Thus, remarkable findings of the measured data and/or of the sensor signal relevant to a diagnosis may be detected even in case of incomplete measured data and/or sensor signals, since all available information has been taken into consideration. Thus, a best possible signal and data analysis can be provided.

The method 40 may execute the collection 410 and/or electronic processing 420 once, continuously, quasi-continuously, repeatedly or upon request. Furthermore, it is also possible to execute the steps 410 and 420 only when checking for a configurable condition and thus as a function of the situational context. The electronic processing 420 may be based on rules of the knowledge base. The determination 430 of the warning signal may comprise a suggestion of a calculated condition in reference to the sepsis and/or a request of the user for confirmation or rejection. The method 40 may comprise a completion 450 of the workflow, whereby the collection 410 and electronic processing 420 can be executed independently of the completion 450 of the workflow, for example, in a parallel or quasiparallel manner. Thus, remarkable condition-relevant findings can be detected even in case of incomplete measured data and/or incomplete sensor signal, since there does not have to be a wait for additional, still missing sensor signals, for example, during the completion 450 of the workflow. The method 40 may, furthermore, comprise an updating 460 of a position in the workflow and a continuation of the workflow at the updated position.

With the warning signal related to the condition “organ dysfunction,” the method 40 can indicate a possible infection and the increased urgency for checking and confirmation of the infection to the user. As a result, the sensitivity of the method 40 can be further increased, so that an early indication can be determined and/or outputted for the detection of a “septic shock” or of a “severe sepsis” even without an initially already confirmed infection. In a preferred embodiment, a new condition “organ dysfunction” is thus introduced, wherein a corresponding signal is visualized as early as possible according to the workflow. When the signal for organ dysfunction is consequently outputted on the display, the signal draws the attention of the user to the request for confirmation, on the one hand, and to the potential risk of a “severe sepsis” or of a “septic shock” of the patient, on the other hand. As a result, the high urgency of checking for an infection is explained and the detection of a “severe sepsis” or of a “septic shock” can be accelerated. The sensitivity of the method 40 is thus increased.

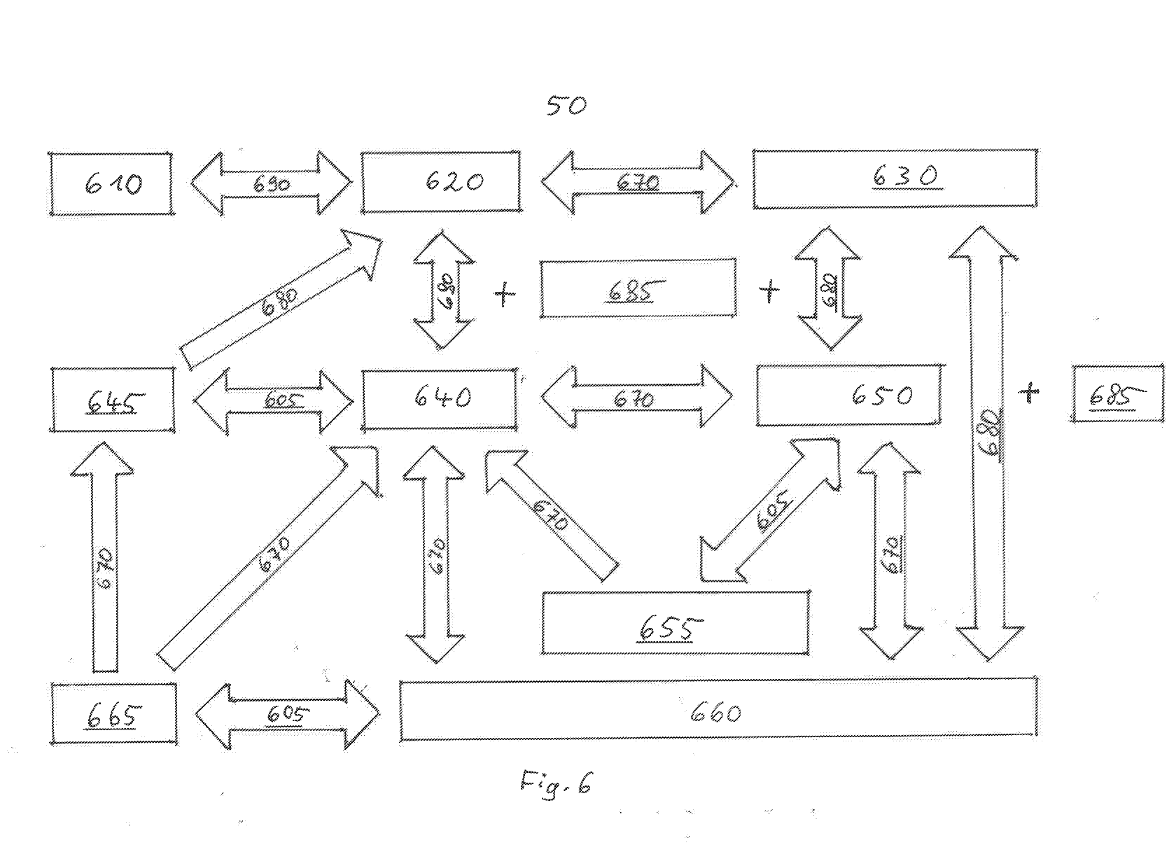

FIG. 6 shows a schematic view of a simplified workflow 50 the early detection of a septic condition according to a preferred embodiment of the present invention.

The simplified workflow 50 comprises the signals related to the sepsis conditions “no SIRS” 610, “SIRS” 620, “organ dysfunction” 630, “sepsis” 640, “severe sepsis” 650 and “septic shock” 660 as well as the conditions confirmed by a user by manual confirmation 605 with the auxiliary signals related to the sepsis conditions “confirmed sepsis” 645, “confirmed severe sepsis” 655 and “confirmed septic shock” 665. The workflow comprises, furthermore, the transitions “organ dysfunctions” 670, by means of which corresponding measured data can be automatically analyzed, “infections” 680 with “reason for infection” 685, the sensor signals and data thereof can be generated and inputted manually by the user and can then be automatically analyzed, as well as “SIRS data” 690, by means of which corresponding measured data can be analyzed automatically. When measured data related to the transition “SIRS data” 690 reach unremarkable normal values, the auxiliary signal related to the condition “confirmed sepsis” 645 remains in force until the user cancels this condition. The method can indicate a possible infection and the increased urgency for checking and confirming the infection to the user by means of the conditions “organ dysfunction” as well as “confirmed sepsis,” “confirmed severe sepsis” and “confirmed septic shock” added to the guideline with the corresponding auxiliary signals as well as the corresponding confirmations “organ dysfunctions,” “infections” and “reasons for infections.” As a result, the sensitivity of the method can be further increased, so that an early detection of a “severe sepsis” or of a “septic shock” can be detected at least indicatively even without an initially already confirmed infection.

The following table illustrates the function of a system according to the state of the art and the function of a system according to an embodiment of the present invention in an exemplary course of a clinical situation by comparison.

| | | System according to |
|---|---|---|
| | System according to | an embodiment of the |
| Clinical situation | the state of the art | present invention |
| Patient with polytrauma | | |
| is transferred to intensive | | |
| care postoperatively | | |
| Patient is monitored | | |
| and ventilated | | |
| Heart rate rises | “Test/data incomplete” | “SIRS positive/check |
| | | for infection” |
| Additional rise in | “Test/data incomplete” | “SIRS positive/check |
| temperature | | for infection” |
| Blood pressure drops | “Test/data incomplete” | “SIRS & organ |
| | | dysfunction |
| | | positive/check |
| | | for infection: |
| | “Test/data incomplete” | User: Infection |
| | | positive |
| | “Test/data incomplete” | “Severe sepsis” |
| | “Test/data incomplete” | User: Therapy |
| | | initiated |
| | “Test/data incomplete” | |

The system according to the state of the art cannot detect the exacerbation of the condition of the patient and thus cannot display corresponding indications thereof. In the extreme case, the system remains suspended during the question of whether an infection is present.

The system according to an embodiment of the present invention can indicate the acute exacerbation of the patient to the user when an organ dysfunction is present, without the checking for infection having to be carried out for this initially.

In conclusion, it should be pointed out that the above description of the present invention with the exemplary embodiments is, in principle, defined as nonlimiting with respect to a specific physical implementation of the present invention. Thus, it is especially obvious to a person skilled in the art that the present invention is, in principle, not limited to the implementation of specific sepsis directives or specific monitor types, but rather may likewise also be used for other directives or monitors in stand-alone devices. Thus, it is also possible to resort to an RPC-based (Remote Procedure Call) and/or web service-based communications technology. For example, proprietary protocols may also be used here for process communication. Furthermore, the above list of medical devices which exchange data (blood pressure measuring device, anesthesia device, body temperature measuring device, etc.) is defined as nonlimiting and may also be extended to other or additional devices. In addition, the present invention may be implemented partly or entirely in software and/or in hardware. In addition, the monitoring unit or the control unit thereof may also be embodied as distributed to a plurality of physical products, including computer program products. Thus, it is possible to implement a part of the monitoring and/or control on a (e.g., mobile) terminal and a remaining part, which runs on a server (e.g., on the a patient data management system).

While specific embodiments of the invention have been shown and described in detail to illustrate the application of the principles of the invention, it will be understood that the invention may be embodied otherwise without departing from such principles.

1. A method for signal and data analysis for the determination of warning signals for pathological conditions by means of an analysis device associated with one or more user terminal, the method comprising the steps:
collecting measured data from a patient data management system by means of a data interface of the analysis device;
displaying at least some of the measured data by means of a display of one of the one or more user terminal, which display can be coupled to the analysis device;
analyzing a first data set of the measured data, wherein the first data set is relevant to a first pathological condition;
determining a first auxiliary signal for the first condition when a result of the analysis of the first data set is positive;
analyzing a sensor signal of the one of the one or more user terminal when the first auxiliary signal has been determined beforehand, wherein the sensor signal is relevant to a second pathological condition;
determining a second auxiliary signal for the second pathological condition when a result of the analysis of the sensor signal is positive;
analyzing a second data set of the measured data when the second auxiliary signal has been determined beforehand, wherein the second data set is relevant to a third pathological condition and is different from the first data set;
determining a third auxiliary signal for a third condition when a result of the analysis of the second data set is positive;
displaying a most recently determined auxiliary signal in each case by means of a display of one of the one or more user terminal, which display can be coupled to the analysis device;
analyzing a third data set of the measured data when the first auxiliary signal has been determined beforehand, wherein the third data set is relevant to a fourth pathological condition and is different from the first data set;
determining a fourth auxiliary signal for the fourth condition when a result of the analysis of the third data set is positive;
analyzing the sensor signal of the one of the one or more user terminal when the fourth auxiliary signal has been determined beforehand; and
determining the third auxiliary signal for the third condition when a result of the analysis of the sensor signal is positive and the fourth auxiliary signal has been determined beforehand.

2. A method in accordance with claim 1, wherein the analyses are executed according to a workflow.

3. A method in accordance with claim 1, wherein the most recently determined auxiliary signal in each case is displayed by the display of one of the one or more user terminal, which display can be coupled to the analysis device, and that with the output of the auxiliary signal, a corresponding request signal in each case is displayed by the display of one of the one or more user terminal, which display is coupled to the analysis device, to confirm or reject the corresponding condition by a manual entry.

4. A method in accordance with claim 1, wherein each analysis of a data set is carried out by comparing values of the data set with a respective, one or more corresponding normal value ranges, wherein the analysis is positive when at least one value exceeds a corresponding normal value range or when a specific group of the values of the data set or all values of the data set exceed the corresponding normal value range.

5. A method in accordance with claim 1, wherein the analysis of the sensor signal is positive when a sensor signal value of the sensor signal or the gradient thereof exceeds a respective, corresponding threshold value.

6. A method in accordance with claim 1, wherein the sensor signal of the user terminal is detected by a user input unit (sensor/touch/button) of the one of the one or more user terminal.

7. A method in accordance with claim 6, wherein the sensor signal is generated by a user query, which user query takes place when the auxiliary signal corresponding to the first or to the fourth condition is determined.

8. A method in accordance with claim 1, wherein a list with entries is visualized on the display of the one of the one or more user terminal for the user query, wherein a corresponding sensor signal is associated with each entry.

9. A method in accordance with claim 1, wherein the third data set is equal to the second data set.

10. A method in accordance with claim 1, wherein the second auxiliary signal for the second pathological condition is determined when a positive result of the analysis of the sensor signal and a positive result of the analysis of the third data set are both generated.

11. A method according to claim 1, wherein a computer program is stored on a data medium or in a memory of a computer or an electronic device and comprises commands that can be read by the computer or by the device, which commands are determined for executing the method steps.

12. An analysis device for signal and data analysis for determining warning signals for pathological conditions, the device comprising:
a data interface to a medical device or to a patient data management system or to both a medical device and to a patient data management system, for collecting measured data;
an output interface to a display of a user terminal for displaying at least some of the measured data;
a sensor signal interface to a user input unit of the user terminal for detecting a corresponding sensor signal; and
a processor for processing at least some of the measured data and the sensor signal,
wherein the processor is configured to analyze a first data set of the measured data, wherein the first data set is relevant to a first condition, and wherein the processor is configured to determine a first auxiliary signal for the first condition when a result of the analysis of the first data set is positive, and
wherein the processor is configured to analyze a sensor signal of the user terminal when the first auxiliary signal has been determined beforehand, wherein the sensor signal is relevant to a second condition, and wherein the processor is configured for a determination of a second auxiliary signal for the second condition when a result of the analysis of the sensor signal is positive and,
wherein the processor is configured to analyze a second data set of the measured data when the second auxiliary signal has been determined beforehand, wherein the second data set is relevant to a third condition and is different from the first data set, and wherein the processor is configured for a determination of a third auxiliary signal for the third condition when a result of the analysis of the second data set is positive and,
the processor is configured to analyze a third data set of the measured data when the first auxiliary signal has been determined beforehand, wherein the third data set is relevant to a fourth condition and is different from the first data set, wherein the processor is configured for a determination of a fourth auxiliary signal for the fourth condition when a result of the analysis of the third data set is positive, and
the processor is configured to analyze the sensor signal of the user terminal when the fourth auxiliary signal has been determined beforehand, and wherein the processor is configured for a determination of the third auxiliary signal when a result of the analysis of the sensor signal is positive and the fourth auxiliary signal has been determined beforehand.

13. An analysis device in accordance with claim 12, wherein the processor is configured to execute analyses according to a workflow.

14. An analysis device in accordance with claim 12, wherein the workflow is based on rules that are stored in a rule repository of the device.

15. A system for signal and data analysis for determining warning signals for pathological conditions, the system comprising:
an analysis device for signal and data analysis for determining warning signals for pathological conditions,
a user terminal with a display and user input unit;
a medical device, and
a patient data management system for providing measured data, wherein the analysis device comprises:
a data interface to a medical device or to a patient data management system or to both a medical device and to a patient data management system, for collecting measured data;
an output interface to the display of the user terminal for displaying at least some of the measured data;
a sensor signal interface to the user input unit of the user terminal for detecting a corresponding sensor signal; and
a processor for processing at least some of the measured data and the sensor signal, wherein the processor is configured to analyze a first data set of the measured data, wherein the first data set is relevant to a first condition, and wherein the processor is configured to determine a first auxiliary signal for the first condition when a result of the analysis of the first data set is positive, and wherein the processor is configured to analyze a sensor signal of the user terminal when the first auxiliary signal has been determined beforehand, wherein the sensor signal is relevant to a second condition, and wherein the processor is configured for a determination of a second auxiliary signal for the second condition when a result of the analysis of the sensor signal is positive and, wherein the processor is configured to analyze a second data set of the measured data when the second auxiliary signal has been determined beforehand, wherein the second data set is relevant to a third condition and is different from the first data set, and wherein the processor is configured for a determination of a third auxiliary signal for the third condition when a result of the analysis of the second data set is positive and, the processor is configured to analyze a third data set of the measured data when the first auxiliary signal has been determined beforehand, wherein the third data set is relevant to a fourth condition and is different from the first data set, wherein the processor is configured for a determination of a fourth auxiliary signal for the fourth condition when a result of the analysis of the third data set is positive, and the processor is configured to analyze the sensor signal of the user terminal when the fourth auxiliary signal has been determined beforehand, and wherein the processor is configured for a determination of the third auxiliary signal when a result of the analysis of the sensor signal is positive and the fourth auxiliary signal has been determined beforehand.

16. A system in accordance with claim 15, wherein that the user terminal is a mobile terminal, or a telecommunications terminal.

17. A system in accordance with claim 15, wherein the user input unit is integrated into the display as a touch-sensitive display.
